(19) United States
(12) Patent Application Publication
(10) Pub. No.: US 2024/0295964 A1
(43) Pub. Date: Sep. 5, 2024

(54) MEMORY CONTROLLER AND FLASH MEMORY SYSTEM

(71) Applicant: TDK CORPORATION, Tokyo (JP)

(72) Inventor: Kenichi TAKUBO, Tokyo (JP)

(73) Assignee: TDK CORPORATION, Tokyo (JP)

(21) Appl. No.: 18/027,518

(22) PCT Filed: Nov. 30, 2021
(86) PCT No.: PCT/JP2021/043727

§ 371 Date: Mar. 21, 2023

(51) Int. Cl. G06F 3/06

(52) U.S. Cl. CPC G06F 3/0613; G06F 3/0659; G06F 3/0679

(57) ABSTRACT

A memory controller includes a microprocessor executing access processing for data on a flash memory and update processing of updating predetermined region management information in accordance with the access processing. Based on the region management information defining correspondences between logical addresses of logical pages and virtual addresses of virtual pages included in a virtual block including physical blocks belonging to multiple channels of the flash memory, the microprocessor determines one of the virtual addresses to be accessed during the access processing. In executing write processing as the access processing based on the virtual address thus determined, the microprocessor edits the region management information on a cache region at every execution of the write processing, and executes the update processing on the region management information, by writing and saving the edited region management information into the flash memory with a frequency reduced as compared with every execution of the write processing.

### TECHNICAL FIELD

The disclosure relates to a memory controller and a flash memory system.

### BACKGROUND ART

A memory controller that controls a nonvolatile memory such as a flash memory, and a memory system including such a memory controller and the nonvolatile memory, such as a flash memory system, have been proposed (see Patent Literature 1, for example).

### CITATION LIST

### Patent Literature

Patent Literature 1: Japanese Unexamined Patent Application Publication (Published Japanese Translation of PCT Application) No. JP2021-520021

### SUMMARY

A memory controller according to an embodiment of the disclosure is configured to control a flash memory. The memory controller includes a microprocessor configured to execute each of access processing for data on the flash memory and update processing of updating predetermined region management information in accordance with the access processing. The microprocessor is configured to determine, on the basis of the region management information that defines correspondences between logical addresses of logical pages and virtual addresses of virtual pages included in a virtual block including multiple physical blocks belonging to multiple channels of the flash memory, one of the virtual addresses that is to be accessed during the access processing. The microprocessor is configured to, in executing write processing for the data as the access processing on the basis of the one of the virtual addresses thus determined, perform editing of the region management information on a cache region every time the microprocessor executes the write processing, and execute the update processing on the region management information, by writing and saving the region management information after the editing into the flash memory with a frequency reduced as compared with every execution of the write processing.

A flash memory system according to an embodiment of the disclosure includes a memory controller configured to control a flash memory, and the flash memory. The memory controller includes a microprocessor configured to execute each of access processing for data on the flash memory and update processing of updating predetermined region management information in accordance with the access processing. The microprocessor is configured to determine, on the basis of the region management information that defines correspondences between logical addresses of logical pages and virtual addresses of virtual pages included in a virtual block including multiple physical blocks belonging to multiple channels of the flash memory, one of the virtual addresses that is to be accessed during the access processing. The microprocessor is configured to, in executing write processing for the data as the access processing on the basis of the one of the virtual addresses thus determined, perform editing of the region management information on a cache region every time the microprocessor executes the write processing, and execute the update processing on the region management information, by writing and saving the region management information after the editing into the flash memory with a frequency reduced as compared with every execution of the write processing.

### BRIEF DESCRIPTION OF THE DRAWINGS

FIG. 1 is a block diagram illustrating a schematic configuration example of systems including a flash memory system according to one example embodiment of the disclosure.

FIG. 2 is a schematic diagram illustrating a schematic configuration example of an address space in a flash memory illustrated in FIG. 1.

FIG. 3 is a schematic diagram illustrating an example of correspondences between logical addresses and physical addresses according to one example embodiment.

FIG. 4 is a schematic diagram illustrating a configuration example of a virtual block, a virtual page, and the like according to one example embodiment.

FIG. 5 is a schematic diagram illustrating a detailed configuration example of the virtual page illustrated in FIG. 4.

FIG. 6 is a schematic diagram illustrating configuration examples of a logical-to-virtual conversion table and a management table according to one example embodiment.

FIG. 7 is a schematic diagram illustrating a placement example of the tables in a table full deployment mode according to one example embodiment.

FIG. 8 is a schematic diagram illustrating a placement example of the tables in a table cache mode according to one example embodiment.

FIG. 9A is a flowchart illustrating an example of a write process (in the table full deployment mode) according to one example embodiment.

FIG. 9B is a flowchart illustrating a processing example that follows FIG. 9A

FIG. 10A is a flowchart illustrating an example of the write process (in the table cache mode) according to one example embodiment.

FIG. 10B is a flowchart illustrating a processing example that follows FIG. 10A.

FIG. 11 is a flowchart illustrating an example of a read process (in the table full deployment mode) according to one example embodiment.

FIG. 12 is a flowchart illustrating an example of the read process (in the table cache mode) according to one example embodiment.

FIG. 13 is a flowchart illustrating an example of activation processing (in the table full deployment mode) according to one example embodiment.

FIG. 14 is a flowchart illustrating an example of the activation processing (in the table cache mode) according to one example embodiment.

### DETAILED DESCRIPTION

It is typically desired that such a memory controller and the like achieve increased efficiency of writing data. It is desirable to provide a memory controller and a flash memory system that each make it possible to increase an efficiency of writing data.

A description is given in detail below of some example embodiments of the disclosure with reference to the drawings. The description is given in the following order.

1. Example Embodiment (an example of writing and saving a logical-to-virtual conversion table with a reduced frequency)

### 2. Modification Examples

### 1. Example Embodiment

### [Schematic Configuration]

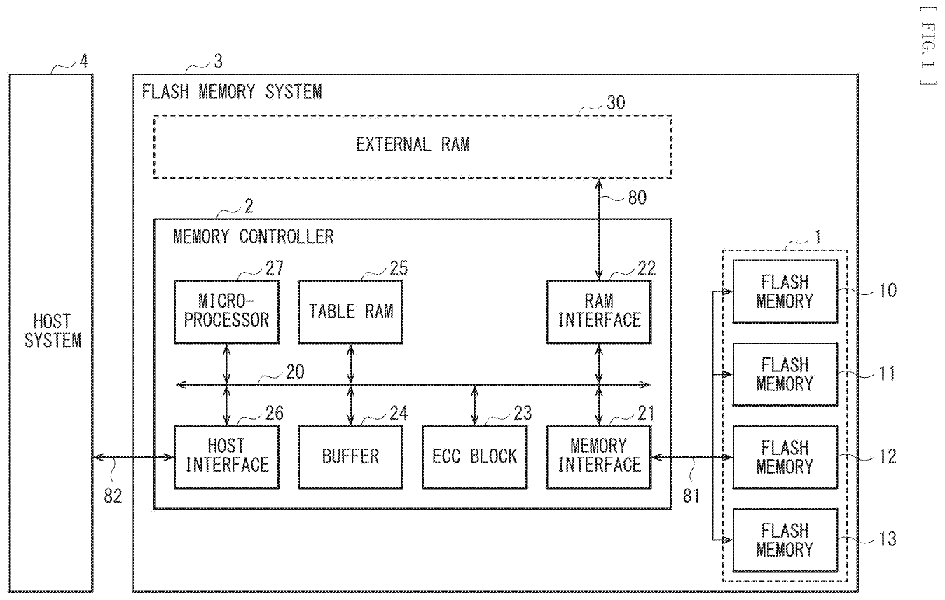

FIG. 1 illustrates a schematic configuration example of a flash memory system (a flash memory system 3) according to an example embodiment of the disclosure, together with an external host system 4, in a block diagram. The flash memory system 3 is a system corresponding to, for example, a solid state drive (SSD), an embedded multimedia card (eMMC), or the like.

As illustrated in FIG. 1, the flash memory system 3 includes a flash memory 1, a memory controller 2, and an external random access memory (RAM) 30. The host system 4 and the memory controller 2 (a host interface 26 to be described later) are coupled to each other via an external bus 82. The memory controller 2 (a memory interface 21 to be described later) and the flash memory 1 are coupled to each other via an internal bus 81. Further, the memory controller 2 (a RAM interface 22 to be described later) and the external RAM 30 are coupled to each other via an internal bus 80.

### (A. Host System 4)

The host system 4 is a host system that uses the flash memory system 3 as a secondary storage device. The host system 4 includes a central processing unit (CPU), a companion chip, and other components. The CPU controls operation of the entire host system 4. The companion chip transmits and receives various pieces of data to and from the flash memory system 3. Such a host system 4 is, for example, an information processor such as a personal computer (PC) or a digital still camera.

Further, the host system 4 supplies a predetermined command to the flash memory system 3 to thereby instruct the flash memory system 3 to execute various kinds of processing. Specifically, the predetermined command is a command for the memory controller 2 in the flash memory system 3 to instruct the flash memory 1 to execute various kinds of processing. Thus, the flash memory 1 performs various kinds of operations in accordance with the command supplied from the memory controller 2.

### (B. Flash Memory 1)

The flash memory 1 is a nonvolatile memory, and includes one or more flash memory chips (chips). In the example of FIG. 1, multiple (four) chips (flash memories 10, 11, 12, and 13) are provided as the flash memory 1 as a whole. In the following description, basically, the flash memories 10 to 13 will be collectively referred to as the flash memory 1. The flash memory 1 is a NAND flash memory, for example. With the NAND flash memory, access processing (write processing or read processing) for data is performed in page units, and erasure processing (batch erasure) for data is performed in block units. Each block includes multiple pages.

In this connection, the page and the block of the flash memory 1 are typically also referred to as a physical page and a physical block, respectively. This is for distinction from a logical page and a logical block which are units to be used by the host system 4 in handling data.

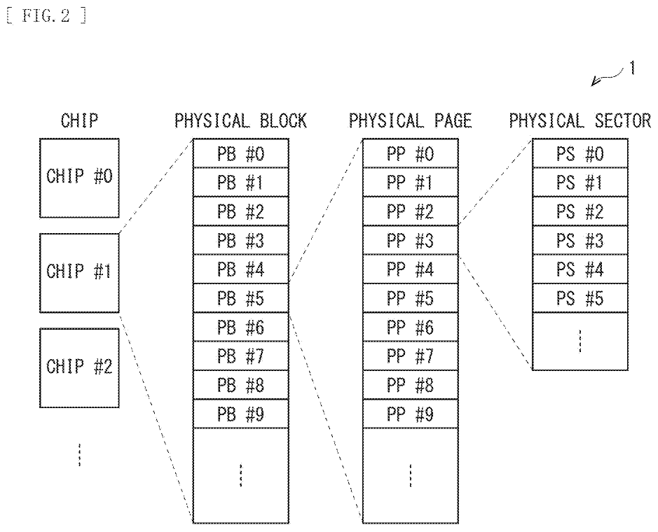

Details of the logical page and the logical block, the physical page and the physical block, and other elements will be described later (FIGS. 2 to 5, for example).

The flash memory 1 includes a register, and a memory cell array in which multiple memory cells are aligned. The memory cell array includes multiple memory cell groups and a word line. Each of the memory cell groups includes multiple ones of the memory cells coupled in series. The word line is provided to select a particular one of the memory cells from the memory cell group. Write processing (a write process) for data from the register into the selected memory cell or read processing (a read process) for data from the selected memory cell to the register is performed between the selected memory cell and the register via the word line.

### (C. Memory Controller 2)

The memory controller 2 controls the flash memory 1 in accordance with a command (the command described above) from the host system 4. Specifically, for example, upon receiving a write request from the host system 4, the memory controller 2 writes data received from the host system 4 into the flash memory 1. Further, for example, upon receiving a read request from the host system 4, the memory controller 2 reads data from the flash memory 1 and transmits the data to the host system 4.

In the present example embodiment, as will be described in detail later, parallel data transfer using multiple channels is performed between the memory controller 2 and the flash memory 1, and between the memory controller 2 and the host system 4.

As illustrated in FIG. 1, for example, the memory controller 2 includes the memory interface 21, the RAM interface 22, an error correcting code (ECC) block 23, a buffer 24, a table RAM 25, the host interface 26, and a microprocessor 27. The memory interface 21, the RAM interface 22, the ECC block 23, the buffer 24, the table RAM 25, the host interface 26, and the microprocessor 27 are coupled to each other via a system bus 20.

The memory interface 21 is an interface used to communicate with the flash memory 1. The memory interface 21 is an interface conforming to, for example, the open NAND flash interface (ONFI) standard.

The RAM interface 22 is an interface used to communicate with the external RAM 30. The external RAM 30 includes, for example, a volatile memory such as a dynamic random access memory (DRAM), and temporarily holds various kinds of data. However, such an external RAM 30 may be provided outside the flash memory system 3.

The ECC block 23 generates an error correcting code (ECC) that is to be added to data to be written into the flash memory 1. Further, the ECC block 23 detects and corrects any error contained in data read from the flash memory 1, on the basis of the error correcting code added to the read data.

The buffer 24 is a part that temporarily holds each of data read from the flash memory 1 and data to be written into the flash memory 1. Specifically, data read from the flash memory 1 is held by the buffer 24 until the host system 4 becomes ready to receive the data. Further, data to be written into the flash memory 1 is held by the buffer 24 until the flash memory 1 becomes ready to be written into.

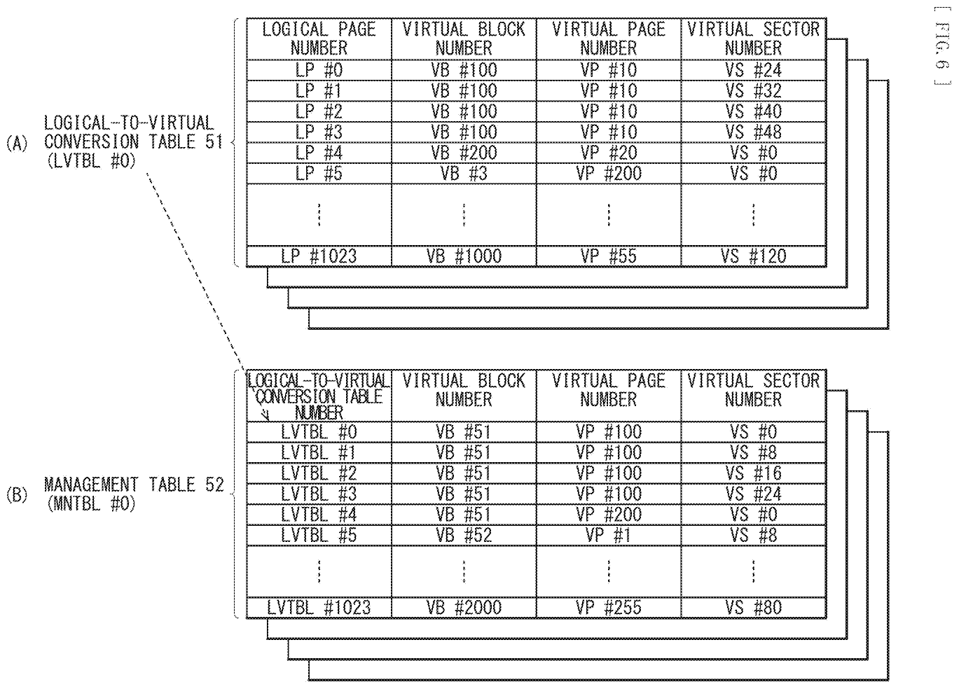

The table RAM 25 is a part in which information necessary in controlling the flash memory 1 is temporarily stored, and includes a volatile memory such as a static random access memory (SRAM). Specifically, various tables (a logical-to-virtual conversion table 51 and a management table 52, see FIG. 6) to be described later are temporarily stored in the table RAM 25, and are to be updated in the table RAM 25 on an as-needed basis.

Such a table RAM 25 corresponds to a specific example of a “cache region” in one embodiment of the disclosure.

The host interface 26 is an interface used to communicate with the host system 4. The host interface 26 is, for example, an interface conforming to the serial advanced technology attachment (SATA) standard or an interface conforming to the peripheral component interconnect-express (PCIe) standard.

The microprocessor 27 is a circuit that controls overall operation of the memory controller 2. Specifically, the microprocessor 27 executes each of access processing (write processing or read processing) for data on the flash memory 1 and update processing of updating the various tables described above in accordance with the access processing.

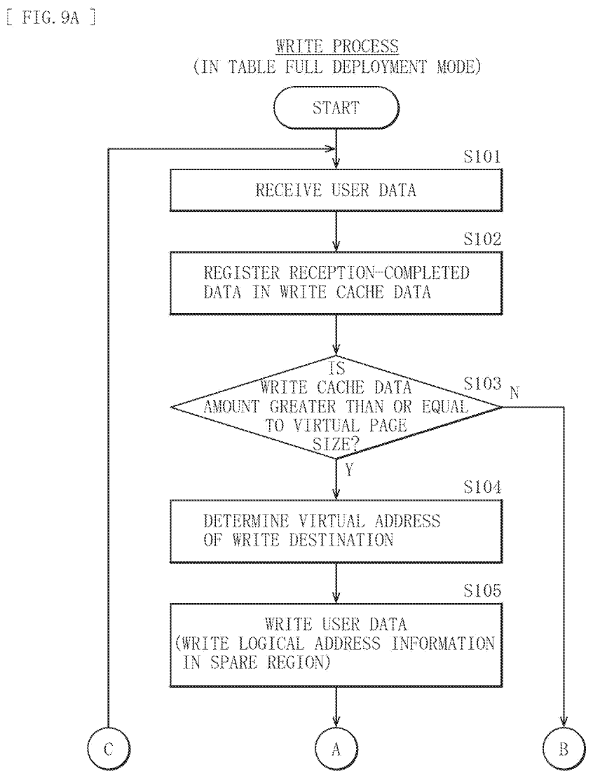

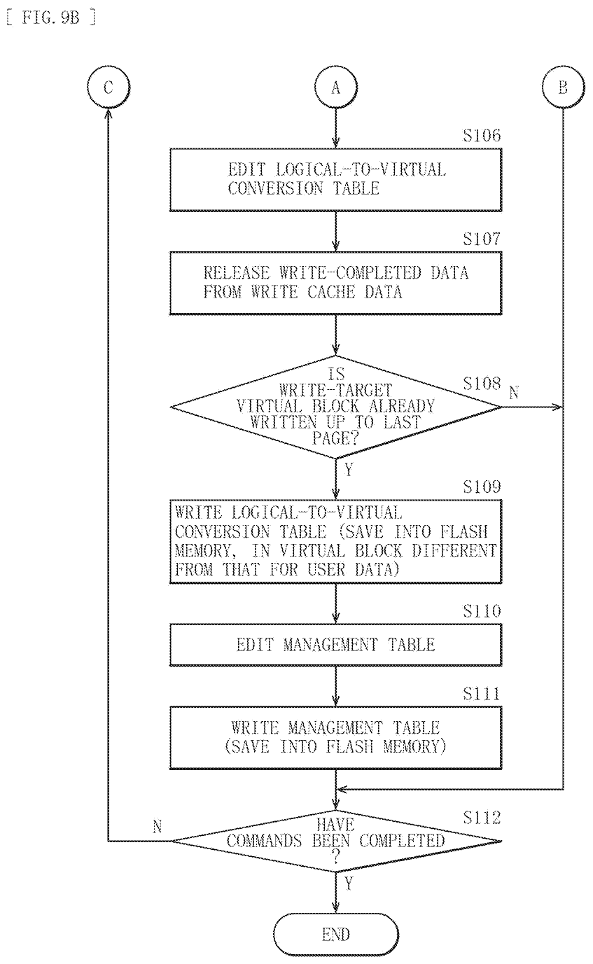

Details of the access processing for data, the update processing on the various tables, and other processing will be described later (FIGS. 9A to 14). [Address Space of Flash Memory 1]

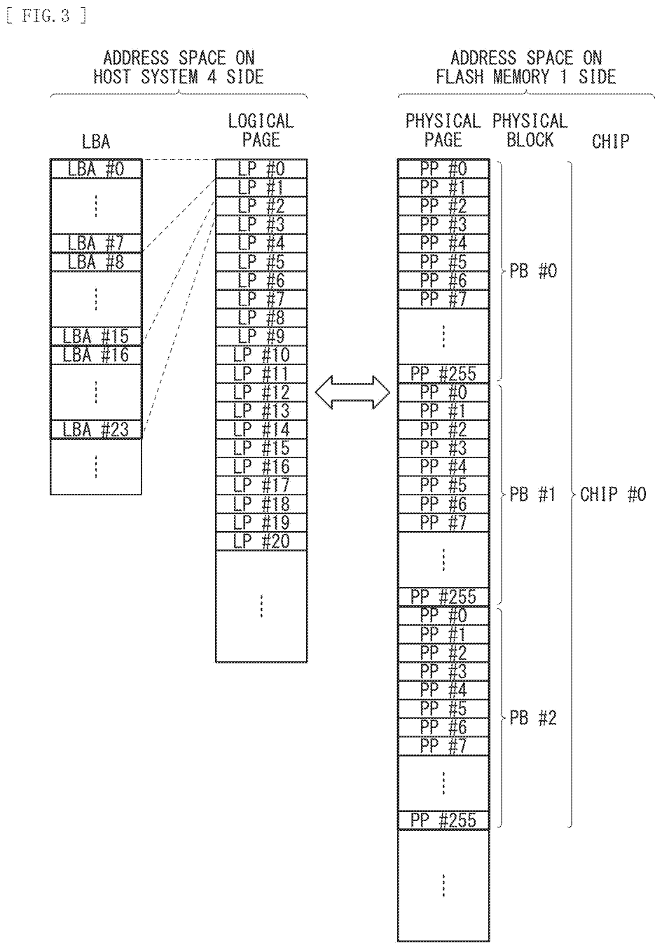

Next, a detailed description will be given of an address space (including a logical address space and a physical address space) of the flash memory 1 with reference to FIGS. 2 and 3.

FIG. 2 is a schematic diagram illustrating a schematic configuration example of the address space of the flash memory 1.

As illustrated in FIG. 2, the flash memory 1 includes the “chips”, “blocks (physical blocks)”, and “pages (physical pages)” which have been described above, and “sectors (physical sectors)”. The flash memory 1 includes at least one chip (in the example of FIG. 1, multiple chips). Each chip includes multiple physical blocks.

The physical blocks are units of processing in data erasure processing to be performed at the flash memory 1. The data erasure processing erases data stored in multiple physical pages belonging to the same physical block all at once. Each physical block includes, for example, 64, 128, or 256 physical pages.

The physical pages are units of processing in the write processing and the read processing for data to be performed at the flash memory 1. In the write processing and the read processing for data, typically, memory cells are selected in physical page units, and writing of data from the register into the memory cells and reading of data from the memory cells to the register are each performed in physical page units.

The physical page includes, for example, 4, 8, or 16 physical sectors. Each physical sector is a region allocated to store data of 512 bytes (data of one sector). Further, the data of one sector stored in each physical sector is stored together with the error correcting code (ECC) relevant to that data.

In the physical page, a region to store data of one sector and a region to store the ECC corresponding to that data of one sector may be alternately allocated. Further, in the physical page, regions to store data of four sectors may be consecutively allocated and thereafter regions to store ECCs corresponding to the data of four sectors may be consecutively allocated. In other words, regions may be allocated to store data of multiple sectors and ECCs for the data alternately in units of several sectors.

For example, as illustrated in FIG. 2, the chips, the physical blocks, the physical pages, and the physical sectors are assigned the following respective serial numbers. That is, chip numbers CHIP #0, CHIP #1, CHIP #2, . . . , physical block numbers PB #0, PB #1, PB #2, . . . , physical page numbers PP #0, PP #1, PP #2, . . . , and physical sector numbers PS #0, PS #1, PS #2, . . . are assigned as the serial numbers. Such chip numbers, physical block numbers, physical page numbers, and physical sector numbers are used as physical addresses which are pieces of information indicating respective storage locations of pieces of data stored in the flash memory 1.

More specifically, the chip numbers CHIP #0, CHIP #1, CHIP #2, . . . are numbers used to identify individual chips in the flash memory 1. The physical block numbers PB #0, PB #1, PB #2, . . . are numbers used to identify individual physical blocks in the chip. The physical page numbers PP #0, PP #1, PP #2, . . . are numbers used to identify individual physical pages in the physical block. The physical sector numbers PS #0, PS #1, PS #2, . . . are numbers used to identify individual physical sectors in the physical page.

Furthermore, it is possible to identify a physical block in the flash memory 1 by combining any of the chip numbers and any of the physical block numbers. For example, “CHIP #0, PB #1”, which is a combination of a chip number and a physical block number, corresponds to the physical block PB #1 among the multiple physical blocks included in the chip CHIP #0. Likewise, it is possible to identify a physical page in the flash memory 1 by combining any of the chip numbers, any of the physical block numbers, and any of the physical page numbers. Moreover, it is possible to identify a physical sector in the flash memory 1 by combining any of the chip numbers, any of the physical block numbers, any of the physical page numbers, and any of the physical sector numbers.

Next, with reference to FIG. 3, a detailed description will be given of correspondences between logical addresses defined in an address space (a logical address space) on the host system 4 side and the physical addresses defined in the address space (the physical address space) on the flash memory 1 side. FIG. 3 schematically illustrates an example of the correspondences between the logical addresses and the physical addresses. Here, the logical addresses are addresses to be managed at the host system 4 as information to identify pieces of data stored in the flash memory 1.

As illustrated in FIG. 3, in the address space on the host system 4 side, the logical addresses are defined using logical block addresses (LBAs). The LBAs are addresses assigned to logical sectors each having a capacity of 512 bytes. LBA numbers LBA #0, LBA #1, LBA #2, . . . are assigned as serial numbers to the LBAs. The host system 4 designates an access region of data using the LBA. The memory controller 2 identifies the access region in the flash memory 1 on the basis of the access region designated using the LBA.

The memory controller 2 defines a group of multiple LBAs as a logical page. The logical pages correspond to the physical pages on the flash memory 1 side, and are units of processing in write processing and read processing for data on the host system 4 side. As illustrated in FIG. 3, for example, the logical pages are assigned logical page numbers LP #0, LP #1, LP #2, . . . as serial numbers. The logical page numbers LP #0, LP #1, LP #2, . . . correspond to addresses of the logical pages.

The number of LBAs to be allocated to a single logical page is set as follows, for example. That is, in FIG. 3, by way of example, eight LBAs are allocated per logical page in such a manner that the LBAs numbered LBA #0 to #7 are allocated to the logical page LP #0, the LBAs numbered LBA #8 to #15 are allocated to the logical page LP #1, and so on. Because the LBAs are allocated to the logical pages in numerical order in such a manner, correspondences between the LBAs and the logical pages are mutually convertible by simple calculation.

The memory controller 2 performs, in logical page units, address conversion to associate the logical addresses and the physical addresses with each other. In other words, the memory controller 2 manages the addresses in the flash memory 1 using a page mapping scheme. The page mapping scheme is a scheme for the memory controller 2 to manage the addresses by grouping multiple LBAs into a logical page unit.

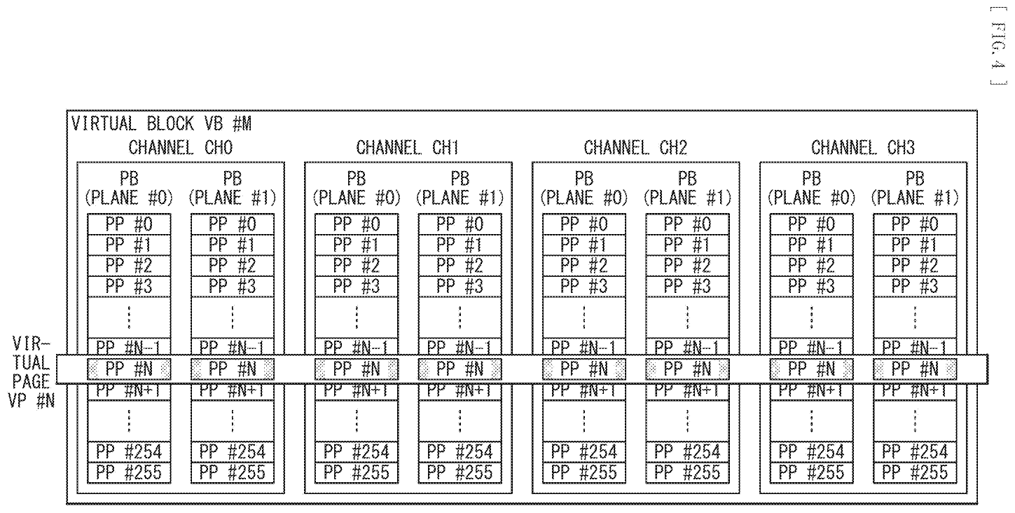

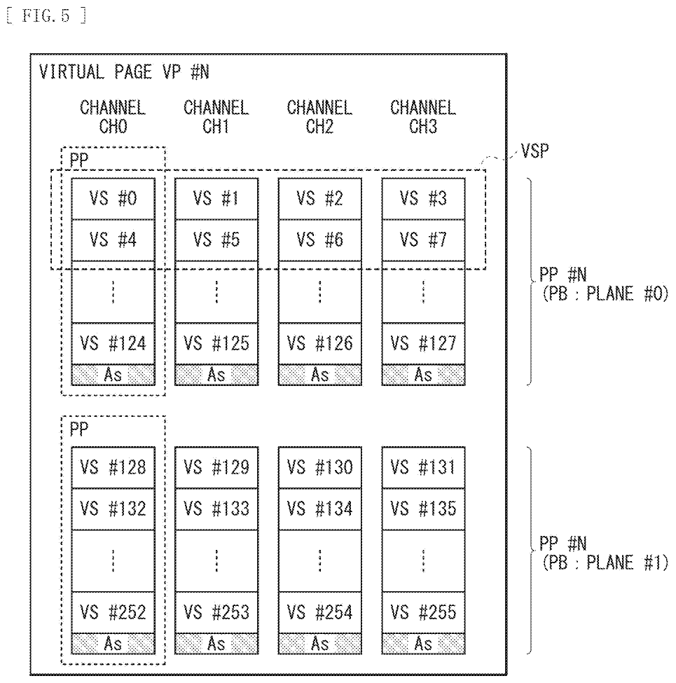

Further, each logical page is allocated to any of virtual subpages included in the flash memory 1. The virtual subpages are subpages divided in a logical page size within a virtual page to be described later, and are placed across multiple physical pages (for example, see a virtual subpage VSP illustrated in FIG. 5 to be described later). Details of the virtual page, the virtual subpage, and the like will be described later (FIGS. 4 and 5).

[Virtual Addresses And the Like in Flash Memory 1]

Next, a detailed description will be given of virtual addresses and the like in the flash memory 1 with reference to FIGS. 4 and 5.

FIG. 4 schematically illustrates a configuration example of the virtual block, the virtual page, and the like according to the present example embodiment. FIG. 5 schematically illustrates a detailed configuration example of the virtual page illustrated in FIG. 4.

First, in the present example embodiment, the memory controller 2 performs the write processing for data in units of virtual pages each including multiple physical pages to be described below, not in typical units of physical pages described above. Further, the memory controller 2 performs the read processing for data in units of virtual sectors to be described below.

As illustrated in FIG. 4, for example, the virtual block includes multiple physical blocks belonging to the above-described multiple channels CHO to CH3. In the example of FIG. 4, the virtual block is assigned a virtual block number VB #M (M is an integer greater than or equal to 0). Further, in the example of FIG. 4, the channels CHO to CH3 are each provided with two physical blocks that respectively belong to two planes (planes #0 and #1). In addition, the two physical blocks in each of the channels CHO to CH3 each include multiple physical pages (256 physical pages assigned physical page numbers PP #0 to PP #255).

As illustrated in FIG. 4, for example, in such a virtual block, a virtual page is configured by multiple physical pages belonging to the multiple channels CHO to CH3. In the example of FIG. 4, the virtual page is assigned a virtual page number VP #N (N is an integer in a range from 0 to 255 both inclusive). Specifically, the virtual page VP #N includes physical pages belonging to the channel CHO (two physical pages PP #N belonging to the respective planes #0 and #1), physical pages (two physical pages PP #N) belonging to the channel CH1, physical pages (two physical pages PP #N) belonging to the channel CH2, and physical pages (two physical pages PP #N) belonging to the channel CH3.

Further, as illustrated in FIG. 5, for example, in the virtual page VP #N, multiple virtual sectors are included in each physical page. In the example of FIG. 5, 256 virtual sectors assigned virtual sector numbers VS #0 to VS #255 are included in the entire virtual page. In addition, these virtual sectors VS #0 to VS #255 are allocated to multiple physical pages (eight physical pages in the example of FIG. 5) in the virtual block, in the order of the virtual sector numbers. Further, in the example of FIG. 5, a logical page is allocated per multiple physical pages in the virtual page. Specifically, the above-described virtual subpages VSP divided in the logical page size are allocated in the order of the virtual sector numbers (in the example of FIG. 5, in the order including eight virtual sector numbers VS #0 to VS #7). Moreover, in the example of FIG. 5, a spare region As is provided for each of the multiple physical pages in the virtual page. Logical address information to be described later is to be written into the spare region As. [Configurations of Various Tables]

Next, a detailed description will be given of configurations of the various tables (the logical-to-virtual conversion table 51 and the management table 52) to be temporarily stored and updated in the table RAM 25 described above.

FIG. 6 schematically illustrates the respective configuration examples of the logical-to-virtual conversion table 51 ((A) of FIG. 6) and the management table 52 ((B) of FIG. 6) according to the present example embodiment.

First, in the present example embodiment, as described above, the virtual pages each including multiple physical pages are units of processing in the access processing (the write processing and the read processing) for data. Accordingly, the memory controller 2 writes data corresponding to each logical page into a virtual page corresponding to the relevant logical page. Further, the correspondences between the addresses of the logical pages, etc. (the logical addresses) and the addresses of the virtual pages, etc. (the virtual addresses) are not fixed but dynamically change depending on the access processing for data.

The memory controller 2 according to the present example embodiment manages such dynamically changing correspondences between the logical addresses and the virtual addresses by using the logical-to-virtual conversion table 51 and the management table 52 as described below. In addition, the memory controller 2 converts a logical address supplied from the host system 4 into a virtual address by referencing each table defining the correspondence therebetween, and identifies, on the basis of the virtual address obtained by the conversion, the storage location of the data to be accessed in the flash memory 1.

The logical-to-virtual conversion table 51 illustrated in (A) of FIG. 6 defines the correspondence between the logical address and the virtual address for each of pieces of data stored in the flash memory 1. Because the memory controller 2 manages the addresses using the page mapping scheme as described above, the logical-to-virtual conversion table 51 also defines the correspondences in page units. Thus, the memory controller 2 manages the correspondences between the logical addresses and the virtual addresses on the basis of correspondences between the addresses of the logical pages (the logical page numbers described above) and the addresses of the virtual pages (the virtual page numbers described above).

More specifically, as illustrated in (A) of FIG. 6, for example, the logical-to-virtual conversion table 51 defines correspondences between the logical page number, the virtual block number, the virtual page number, and the virtual sector number for each of the pieces of data stored in the flash memory 1. Further, as illustrated in (A) of FIG. 6, for example, multiple logical-to-virtual conversion tables 51 are provided in the entire flash memory 1, and each of the logical-to-virtual conversion tables 51 is assigned a unique number (a logical-to-virtual conversion table number such as LVTBL #0). In the example of (A) of FIG. 6, correspondences of 1024 logical addresses (logical address numbers) with virtual addresses are described in each of the logical-to-virtual conversion tables 51.

The logical-to-virtual conversion table 51 corresponds to a specific example of “region management information” in one embodiment of the disclosure.

In contrast, the management table 52 illustrated in (B) of FIG. 6 defines correspondences between the logical-to-virtual conversion table numbers unique to the respective logical-to-virtual conversion tables 51 and addresses of the logical-to-virtual conversion tables 51 (virtual addresses of final save destinations in the flash memory 1). That is, although details will be described later, the logical-to-virtual conversion tables 51 are finally written and saved into the flash memory 1 after being temporarily stored and updated in the table RAM 25.

More specifically, as illustrated in (B) of FIG. 6, for example, the management table 52 defines a correspondence between the logical-to-virtual conversion table number of each of the logical-to-virtual conversion tables 51 and the virtual address (the virtual block number, the virtual page number, and the virtual sector number) of the save destination of relevant one of the logical-to-virtual conversion tables 51. Further, as illustrated in (B) of FIG. 6, for example, multiple management tables 52 are also provided in the entire flash memory 1, and each of the management tables 52 is assigned a unique number (a management table number such as MNTBL #0). In the example of (B) of FIG. 6, correspondences of 1024 logical-to-virtual conversion table numbers with virtual addresses of save destinations are described in each of the management tables 52.

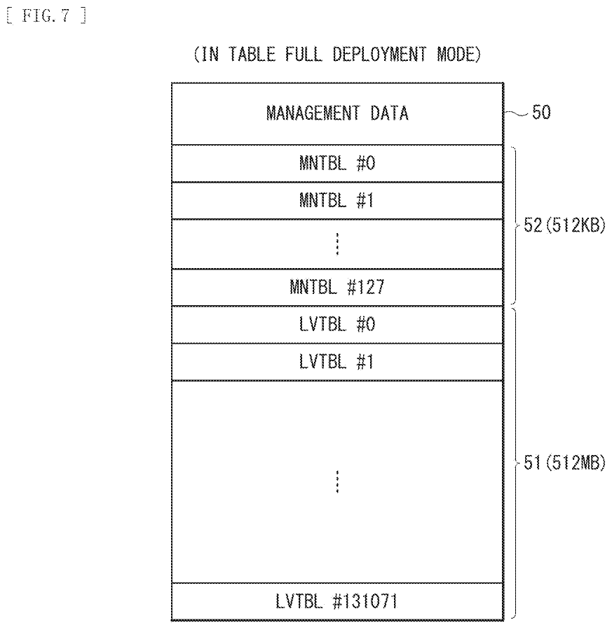

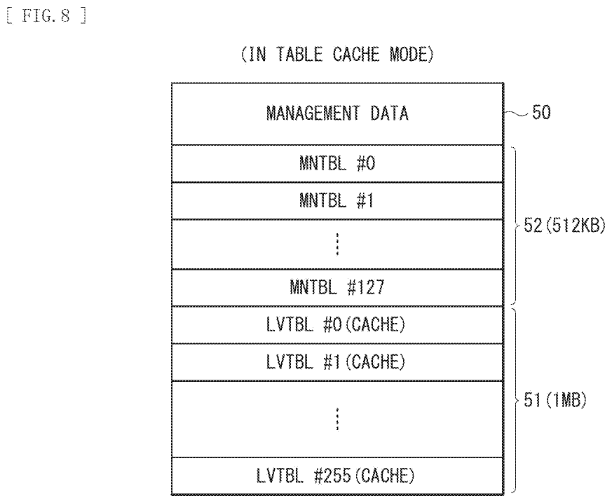

FIG. 7 schematically illustrates a placement example of the tables (the logical-to-virtual conversion tables 51 and the management tables 52) in a table full deployment mode according to the present example embodiment. FIG. 8 schematically illustrates a placement example of the tables in a table cache mode according to the present example embodiment.

First, in the table full deployment mode illustrated in FIG. 7, for example, various management data 50, 131072 logical-to-virtual conversion tables 51 (LVTBL #0 to LVTBL #131071), and 128 management tables 52 (MNTBL #0 to MNTBL #127) are temporarily stored in the table RAM 25. As illustrated in (B) of FIG. 6, each management table 52 includes 1024 logical-to-virtual conversion table numbers of the logical-to-virtual conversion tables 51. Accordingly, in the example of FIG. 7, the number of the logical-to-virtual conversion tables 51 is 131072 (=128 (the number of the management tables 52)×1024).

Therefore, by way of example, in a case where the tables (the logical-to-virtual conversion table 51 and the management table 52) each have a data size of 4 KB, an overall data size of the logical-to-virtual conversion tables 51 in the table full deployment mode is: 4 KB×131072=512 MB, as illustrated in FIG. 7. Further, an overall data size of the management tables 52 in the table full deployment mode is: 4 KB ×128=512 KB, as illustrated in FIG. 7.

In contrast, in the table cache mode illustrated in FIG. 8, for example, the various management data 50, caches of 256 logical-to-virtual conversion tables 51 (LVTBL #0 (cache) to LVTBL #255 (cache)), and the 128 management tables 52 (MNTBL #0 to MNTBL #127) are temporarily stored in the table RAM 25. That is, in the table cache mode, the number corresponding to the logical-to-virtual conversion tables 51 is 256/131072, that is, 512-fold smaller than in the table full deployment mode described above.

Therefore, by way of example, in the case where the tables (the logical-to-virtual conversion tables 51 and the management tables 52) each have a data size of 4 KB, an overall data size of the logical-to-virtual conversion tables 51 in the table cache mode is: 4 KB×256=1 MB, as illustrated in FIG. 8, unlike in the table full deployment mode described above. In contrast, an overall data size of the management tables 52 in the table cache mode is: 4 KB ×128=512 KB, as illustrated in FIG. 8, as in the table full deployment mode described above.

Such logical-to-virtual conversion tables 51 and management tables 52 are each read from the flash memory 1 to the table RAM 25 during activation processing of the flash memory system 3 or during the access processing for data. Further, the memory controller 2 updates each of the logical-to-virtual conversion tables 51 and the management tables 52 on the table RAM 25 on an as-needed basis. The logical-to-virtual conversion tables 51 and the management tables 52 thus updated are each finally written and saved into the flash memory 1 at a predetermined point in time to be described later. Note that such writing of the tables into the flash memory 1 is performed on each of the multiple divided tables illustrated in (A) and (B) of FIG. 6, that is, each of the tables assigned the respective logical-to-virtual conversion table numbers described above and each of the tables assigned the respective management table numbers described above.

[Operations, Workings, and Effects]

Next, a description will be given of operation examples of the flash memory system 3 of the present example embodiment.

First, in the present example embodiment, the microprocessor 27 determines a virtual address to be accessed at the time of access processing for data, on the basis of the logical-to-virtual conversion tables 51 (and the management tables 52) defining the correspondences between the logical addresses and the virtual addresses described above. Further, the microprocessor 27 executes the access processing (write processing or read processing), and also executes update processing of updating the various tables (the logical-to-virtual conversion tables 51 and the management tables 52) in accordance with the access processing.

In the following, examples of operation during the write processing (the write process) and the read processing (the read process) for data will be described in detail for each of the table full deployment mode and the table cache mode. Further, an example of operation during the activation processing when power to the flash memory system 3 (the flash memory 1 and the memory controller 2) returns to an ON state from an OFF state will also be described in detail for each of the two modes. (A-1. Example of Operation during Write Process: in Table Full Deployment Mode)

FIGS. 9A and 9B each illustrate an example of the write process (in the table full deployment mode) according to the present example embodiment in a flowchart.

In a series of processes illustrated in FIGS. 9A and 9B, first, the microprocessor 27 receives user data (write data) supplied from the host system 4 via the host interface 26 (step S101 of FIG. 9A). Next, the microprocessor 27 registers the user data of which reception has been completed (i.e., reception-completed data) in write cache data in the buffer 24 (step S102). Next, the microprocessor 27 determines whether a data amount of the write cache data (i.e., a write cache data amount) in the buffer 24 is greater than or equal to the virtual page size of the flash memory 1 (step S103). In a case where it is determined that the write cache data amount is smaller than the virtual page size (step S103: N), the flow proceeds to step S112 (FIG. 9B) to be described later.

In a case where it is determined that the write cache data amount is greater than or equal to the virtual page size (step S103: Y), the microprocessor 27 next determines a virtual address in the flash memory 1 that is to be a write destination of the user data (step S104), by referencing the logical-to-virtual conversion tables 51 and the management tables 52. Thereafter, on the basis of the virtual address thus determined, the microprocessor 27 writes the user data (the write cache data in the buffer 24) into the flash memory 1 (step S105). Further, at this time, the microprocessor 27 also writes logical address information indicating a corresponding logical address into any spare region As described above (see FIG. 5) in a write-target virtual page.

Next, in association with such write processing for the user data, the microprocessor 27 edits relevant one of the logical-to-virtual conversion tables 51 on the table RAM 25 (step S106 in FIG. 9B). Thereafter, the microprocessor 27 releases the above-described data of which writing has been completed from the write cache data in the buffer 24 (step S107). Thereafter, the microprocessor 27 determines whether a write-target virtual block as a virtual block having been subjected to the writing in the flash memory 1 is already written up to a last page of the multiple virtual pages included in that virtual block (step S108). In a case where it is determined that the write-target virtual block is not yet written up to the last page (step S108: N), the flow proceeds to step S112 (FIG. 9B) to be described later.

In a case where it is determined that the write-target virtual block is already written up to the last page (step S108: Y), the flow proceeds as follows. That is, the microprocessor 27 next writes and saves the logical-to-virtual conversion tables 51 after the editing performed in step S106 into the flash memory 1 (step S109), to thereby execute the update processing on the logical-to-virtual conversion tables 51. Further, at this time, the microprocessor 27 allows the virtual block into which the user data is written during the write processing and a virtual block into which the logical-to-virtual conversion tables 51 after the editing are written and saved to be different from each other in the flash memory 1.

Thereafter, in association with the above-described writing and saving of the logical-to-virtual conversion tables 51 into the flash memory 1, the microprocessor 27 edits relevant one of the management tables 52 on the table RAM 25 (step S110). Thereafter, the microprocessor 27 writes and saves the management tables 52 after the editing in this way into the flash memory 1 (step S111), to thereby execute the update processing on the management tables 52.

Thereafter, the microprocessor 27 determines whether commands for the entire write process have been completed (step S112). In a case where it is determined that the commands for the entire write process have not been completed yet (step S112: N), the flow returns to step S101 (FIG. 9A) described above. In a case where it is determined that the commands for the entire write process have been completed (step S112: Y), the series of processes illustrated in FIGS. 9A and 9B ends. (A-2. Example of Operation during Write Process: in Table Cache Mode)

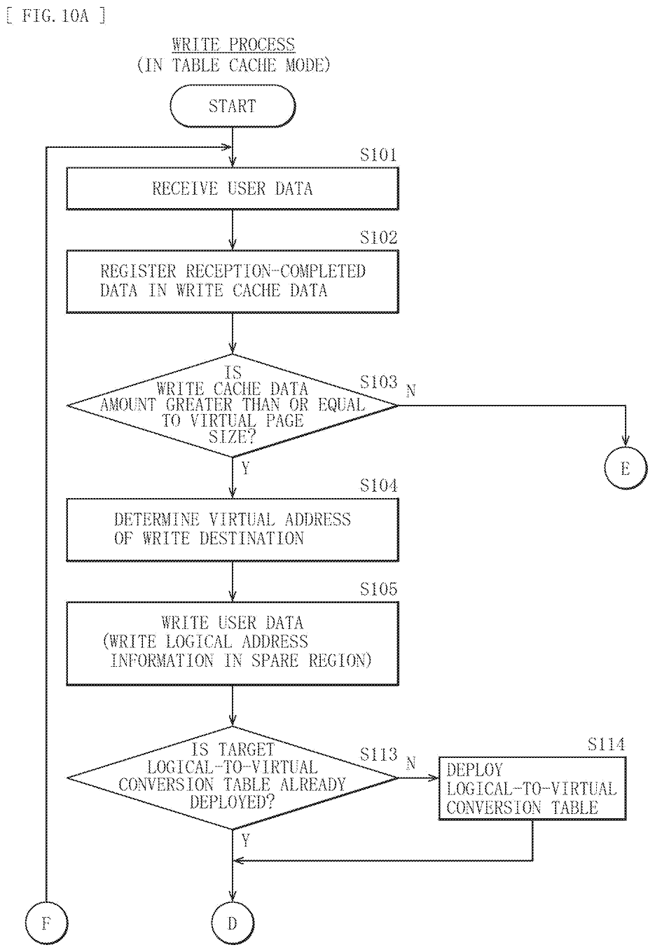

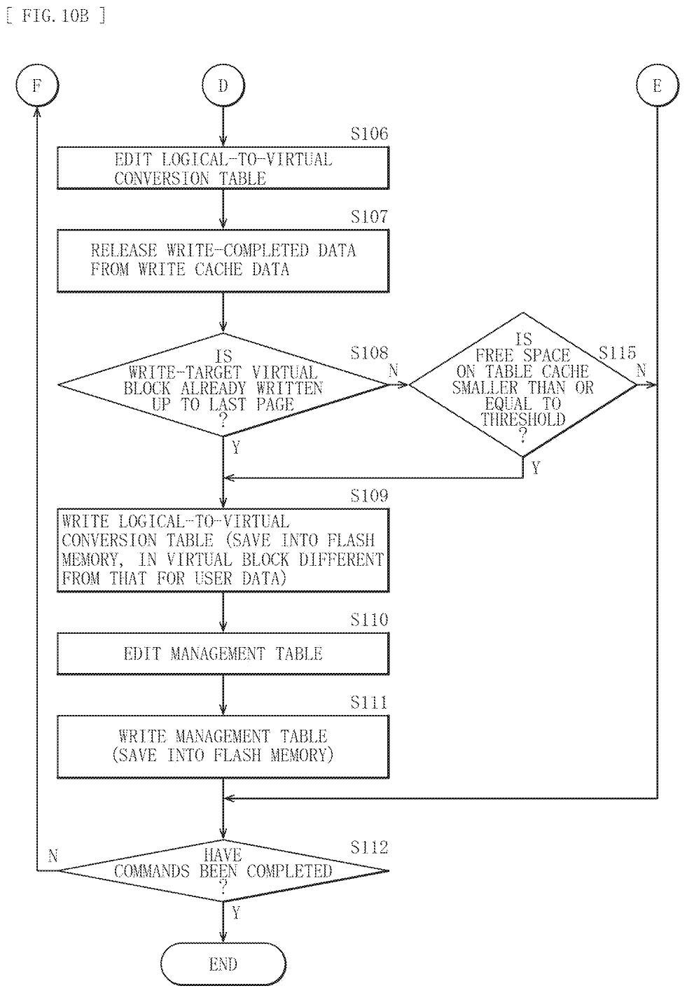

FIGS. 10A and 10B each illustrate an example of the write process (in the table cache mode) according to the present example embodiment in a flowchart.

A series of processes illustrated in FIGS. 10A and 10B corresponds to the foregoing series of processes illustrated in FIGS. 9A and 9B, and additionally includes steps S113 to S115. Thus, a separate description will be given below of these steps S113 to S115.

First, steps S113 and S114 are processes added between steps S105 and S106 described above. Specifically, after step S105 (writing of user data) described above, the microprocessor 27 next determines whether a target logical-to-virtual conversion table 51, i.e., a logical-to-virtual conversion table 51 to be edited, is already deployed (step S113 of FIG. 10A). In a case where it is determined that the target logical-to-virtual conversion table 51 is already deployed (step S113: Y), the flow proceeds to step S106 (editing of the logical-to-virtual conversion table 51, see FIG. 10B) described above. In a case where it is determined that the target logical-to-virtual conversion table 51 is not yet deployed (step S113: N), the microprocessor 27 next deploys the target logical-to-virtual conversion table 51 (step S114 of FIG. 10A). Thereafter, the flow proceeds to step S106 (editing of the logical-to-virtual conversion table 51, see FIG. 10B) in this case also.

Step S115 is a process to be performed in the case where it is determined in step S108 described above that the write-target virtual block is not yet written up to the last page (step $108: N). Specifically, in this case, the microprocessor 27 next determines whether a free space on a table cache in the table RAM 25 is smaller than or equal to a predetermined threshold (step S115 of FIG. 10B). In a case where it is determined that the free space on the table cache exceeds the predetermined threshold (step S115: N), the flow proceeds to step S112 (determination as to whether the commands have been completed) described above. In a case where it is determined that the free space on the table cache is smaller than or equal to the predetermined threshold (step S115: Y), the flow proceeds to step S109 (writing and saving of the logical-to-virtual conversion tables 51) described above.

The description of the series of processes illustrated in FIGS. 10A and 10B thus ends.

In this way, according to the write process of the present example embodiment, the microprocessor 27 executes the update processing on the logical-to-virtual conversion tables 51 by writing and saving the logical-to-virtual conversion tables 51 after editing into the flash memory (step S109) with a frequency reduced as compared with every execution of the write processing for the user data (step S105). Specifically, the microprocessor 27 writes and saves the logical-to-virtual conversion tables 51 after editing into the flash memory 1 in the case where the write processing has been completed up to the last virtual page in the virtual block (step S108: Y) or in the case where the free space on the table cache is smaller than or equal to the predetermined threshold (step S115: Y).

(B-1. Example of Operation during Read Process: in Table Full Deployment Mode)

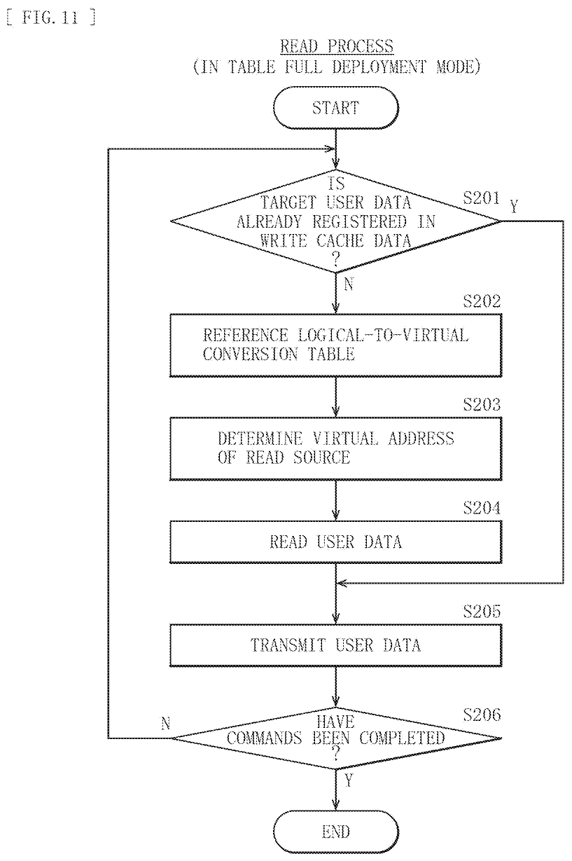

Next, FIG. 11 is a diagram illustrating an example of the read process (in the table full deployment mode) according to the present example embodiment in a flowchart.

In a series of processes illustrated in FIG. 11, the microprocessor 27 first determines whether target user data, i.e., user data to be read, is already registered in the write cache data in the buffer 24 (step S201). In a case where it is determined that the user data to be read is not yet registered in the write cache data (step S201: Y), the flow proceeds to step S205 (transmission of the user data) to be described later.

In a case where it is determined that the user data to be read is not yet registered in the write cache data (step S201: N), the microprocessor 27 next references any of the logical-to-virtual conversion tables 51 (step S202). On the basis of the logical-to-virtual conversion table 51 thus referenced, the microprocessor 27 determines a virtual address corresponding to a read source in the flash memory 1 (step S203).

Thereafter, the microprocessor 27 reads the user data from the flash memory 1 using the virtual address thus determined (step S204). Thereafter, the microprocessor 27 transmits the user data thus read to the host system 4 via the host interface 26 (step S205).

Thereafter, the microprocessor 27 determines whether commands for the entire read process have been completed (step S206). In a case where it is determined that the commands for the entire read process have not been completed yet (step S206: N), the flow returns to step S201 described above. In a case where it is determined that the commands for the entire read process have been completed (step S206: Y), the series of processes illustrated in FIG. 11 ends.

(B-2. Example of Operation during Read Process: in Table Cache Mode)

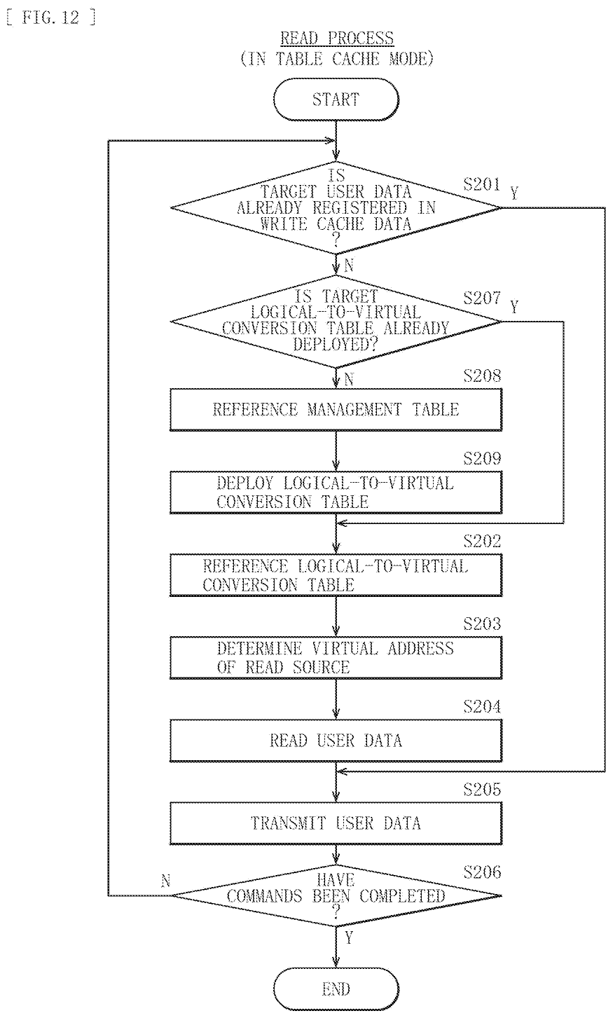

FIG. 12 is a diagram illustrating an example of the read process (in the table cache mode) according to the present example embodiment in a flowchart.

A series of processes illustrated in FIG. 12 corresponds to the foregoing series of processes illustrated in FIG. 11, and additionally includes steps S207 to S209 between steps S201 and S202. Thus, a separate description will be given below of these steps S207 to S209.

First, step S207 is a process to be performed in the case where it is determined in step S201 described above that the user data to be read is not yet registered in the write cache data (step S201: N). Specifically, in this case, the microprocessor 27 next determines whether the target logical-to-virtual conversion table 51 is already deployed (step S207). In a case where it is determined that the target logical-to-virtual conversion table 51 is already deployed (step S207: Y), the flow proceeds to step S202 (referencing of the logical-to-virtual conversion table 51) described above.

In a case where it is determined that the target logical-to-virtual conversion table 51 is not yet deployed (step S207: N), the microprocessor 27 next references relevant one of the management tables 52 (step S208) and deploys the target logical-to-virtual conversion table 51 (step S209). Thereafter, the flow proceeds to step S202 (referencing of the logical-to-virtual conversion table 51) described above.

The description of the series of processes illustrated in FIG. 12 thus ends. (C-1. Example of Operation during Activation Processing: in Table Full Deployment Mode)

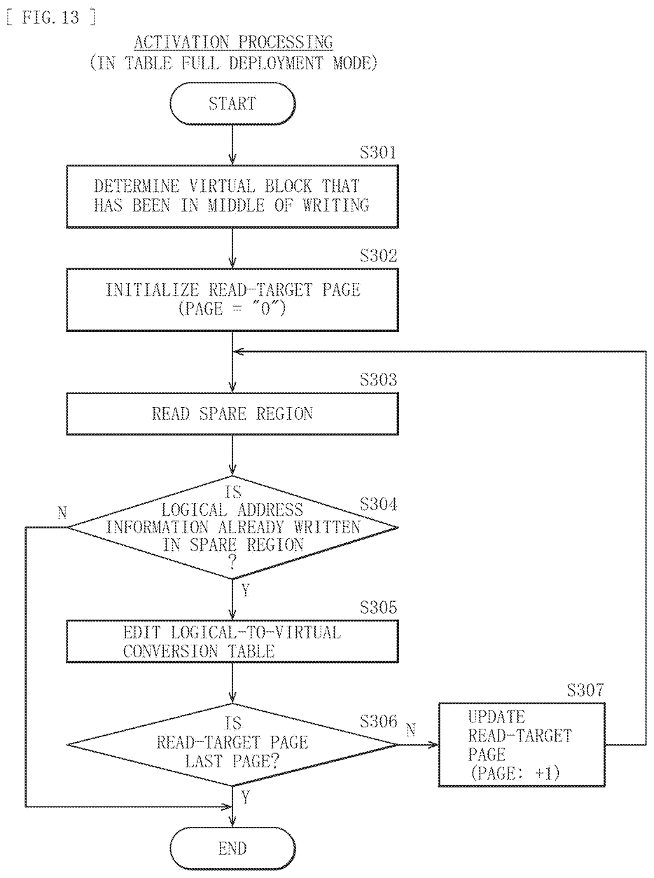

Next, FIG. 13 is a diagram illustrating an example of the foregoing activation processing (in the table full deployment mode) according to the present example embodiment in a flowchart.

The activation processing herein is premised on a case where power to the flash memory system 3 (the flash memory 1 and the memory controller 2) has transitioned from an ON state to an OFF state at a point in time before the logical-to-virtual conversion tables 51 are written and saved into the flash memory 1. In addition, this activation processing is processing to be executed when, after such a premise state, the power to the flash memory system 3 returns to the ON state from the OFF state.

In a series of processes illustrated in FIG. 13, the microprocessor 27 first determines a virtual block that has been in the middle of writing before the above-described return of the power (step S301). Next, the microprocessor 27 initializes a read-target virtual page (page=“0”) in the relevant virtual block (step S302). Thereafter, the microprocessor 27 reads the foregoing spare region As (see FIG. 5) in the read-target virtual page (step $303).

Thereafter, the microprocessor 27 determines whether the logical address information described above (see step S105 of FIGS. 9A and 10A) is already written in the spare region As having been subjected to the reading (step S304). In a case where it is determined that no logical address information is written in the spare region As (step S304: N), the series of processes illustrated in FIG. 13 ends because the target virtual block includes no effective data any further.

In a case where it is determined that the logical address information is already written in the spare region As (step S304: Y), the microprocessor 27 next performs the following process. That is, in this case, the microprocessor 27 reads the already written logical address information from the spare region As and edits any unupdated one of the logical-to-virtual conversion tables 51 on the table RAM 25 by using the logical address information thus read (step S305).

Thereafter, the microprocessor 27 determines whether the current read-target virtual page is the last page in the relevant virtual block (step S306). In a case where the read-target virtual page is not the last page (step S306: N), the microprocessor 27 next performs an update (page: +1) of the read-target virtual page (step S307). Thereafter, the flow returns to step S303 described above.

In a case where it is determined that the read-target virtual page is the last page (step S306: Y), the series of processes illustrated in FIG. 13 ends.

### C-2. Example of Operation during Activation Processing: in Table Cache Mode

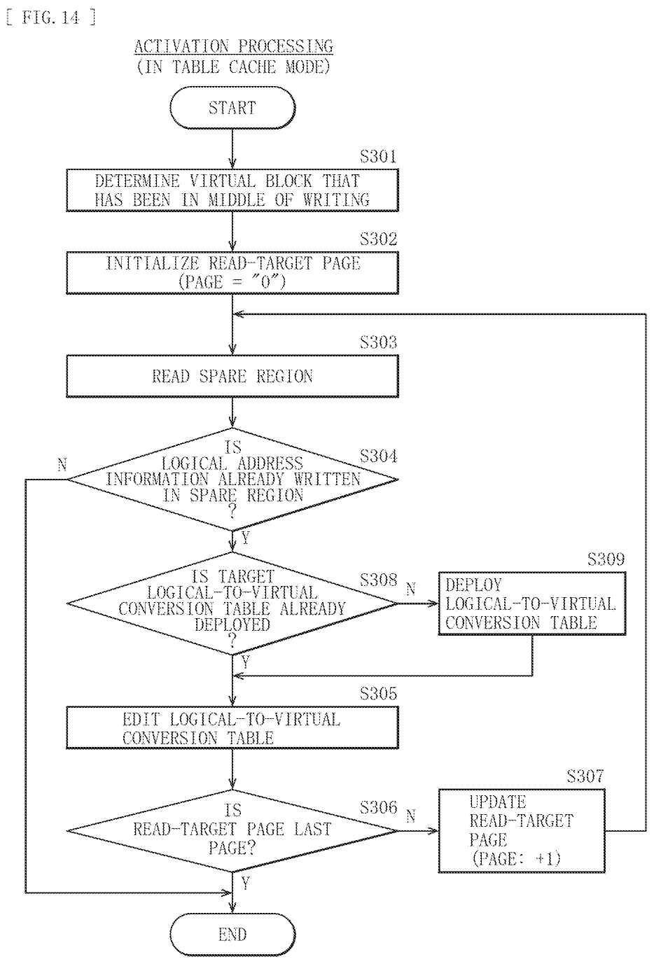

FIG. 14 is a diagram illustrating an example of the foregoing activation processing (in the table cache mode) according to the present example embodiment in a flowchart.

A series of processes illustrated in FIG. 14 corresponds to the foregoing series of processes illustrated in FIG. 13, and additionally includes steps S308 and S309 between steps S304 and S305. Thus, a separate description will be given below of these steps S308 and S309.

First, step S308 is a process to be performed in the case where it is determined in step S304 described above that the logical address information is already written in a read-target spare region As as the spare region As having been subjected to the reading (step S304: Y). Specifically, in this case, the microprocessor 27 next determines whether a target logical-to-virtual conversion table 51, i.e., a logical-to-virtual conversion table 51 to be edited, is already deployed (step S308). In a case where it is determined that the target logical-to-virtual conversion table 51 is already deployed (step S308: Y), the flow proceeds to step S305 (editing of the logical-to-virtual conversion table 51) described above.

In a case where it is determined that the target logical-to-virtual conversion table 51 is not yet deployed (step S308: N), the microprocessor 27 next deploys the target logical-to-virtual conversion table 51 (step S309). Thereafter, the flow proceeds to step S305 (editing of the logical-to-virtual conversion table 51) described above.

The description of the series of processes illustrated in FIG. 14 thus ends.

### D. Workings and Effects

In this way, according to the present example embodiment, editing of any of the logical-to-virtual conversion tables 51 is performed on the table RAM 25 every time the write processing for data (user data) is executed. In addition, the logical-to-virtual conversion tables 51 after the editing are written and saved into the flash memory 1 with a frequency reduced as compared with every execution of the write processing. The update processing on the logical-to-virtual conversion tables 51 is thereby executed.

The present example embodiment thus provides the following result, as compared with a case (a comparative example) where a logical-to-physical conversion table (a table that defines correspondences between logical addresses and physical addresses) is edited and thereafter written and saved into a flash memory at every execution of write processing for data using the page mapping scheme, for example. That is, according to the technique of the comparative example, the frequency of writing the logical-to-physical conversion table into the flash memory increases in a case of random access write processing, for example. This can result in degraded efficiency of writing data. In contrast, according to the present example embodiment, update frequency of the logical-to-virtual conversion tables 51 is low even in the case of such random access write processing, for example. It is thus possible to increase the efficiency of writing data, as compared with a case of the comparative example.

Further, according to the present example embodiment, the virtual block into which the user data is written during the write processing and the virtual block into which the logical-to-virtual conversion tables 51 after the editing are written and saved are different from each other in the flash memory 1. This provides the following result. That is, according to the present example embodiment, update frequencies are mutually different between the user data and the logical-to-virtual conversion tables 51. Accordingly, for example, in a case where the above-described virtual blocks are allowed to be coincident with each other, some inconvenience can be caused in performing garbage collection. By allowing the above-described virtual blocks to be different from each other, it is thus possible to avoid the possibility of any inconvenience being caused in performing garbage collection. This allows a further increase in efficiency of writing data.

Moreover, according to the present example embodiment, during the activation processing described above, the logical address information which was written together with data at the time of the write processing for the data is read from the spare regions As included in the virtual block that has been in the middle of writing. Thereafter, using the logical address information thus read, any unupdated one of the logical-to-virtual conversion tables 51 is edited on the table RAM 25. Thus, according to the present example embodiment, even in a case where, for example, power to the flash memory system 3 has transitioned from the ON state to the OFF state at a point in time before the logical-to-virtual conversion tables 51 are written and saved into the flash memory 1, the update processing (editing) on the unupdated one of the logical-to-virtual conversion tables 51 is reliably executable during the activation processing thereafter. As a result, the present example embodiment makes it possible to increase reliability of the flash memory system 3.

### 2. Modification Examples

Although the disclosure has been described above with reference to the example embodiment, the disclosure is not limited to such an example embodiment, and may be modified in a variety of ways.

For example, although the description has been given specifically of the respective configurations of the host system, the flash memory, and the memory controller in the foregoing example embodiment, their respective configurations are not limited to those described in the foregoing example embodiment. Specifically, an example case where the flash memory 1 is a NAND flash memory has been described in the foregoing example embodiment, for example. However, this is a non-limiting example, and a NOR flash memory may be used as the flash memory 1, for example.

Further, in the foregoing example embodiment, the description has been given of an example case where the logical-to-virtual conversion tables 51 and the management tables 52 are each created and updated (edited) on the table RAM 25 in the memory controller 2, and are written and saved into the flash memory 1. However, this is a non-limiting example, and the logical-to-virtual conversion tables 51 and the management tables 52 may be created and updated on another non-volatile memory (e.g., the external RAM 30) outside the memory controller 2, or at a location outside the flash memory system 3, for example. Further, the correspondences between pieces of information in the logical-to-virtual conversion tables 51 and the management tables 52 need not necessarily be defined by the form described in the foregoing example embodiment, and may be defined by another form. In addition, the correspondences between such pieces of information (e.g., the correspondence between the logical addresses and the virtual addresses) need not necessarily be defined by the table form, and may be defined by another form.

Further, the number of the physical blocks included in each chip, the number of the physical pages included in each physical block, the number of the physical sectors included in each physical page, the number of the physical blocks included in each virtual block, the number of the physical pages included in each virtual page, the number of the LBAs included in each logical page, etc. described in the foregoing example embodiment are mere examples, and other numeric values may be chosen.

Moreover, in the foregoing example embodiment, the description has specifically been given of respective examples of operations to be performed by the microprocessor 27 during the access processing (the read process and the write process) for data, the update processing on the tables, and the activation processing. However, such various processing examples are not limited to those described in the foregoing example embodiment, and any of other techniques may be used to perform these various kinds of processing examples.

In addition, any two or more of the configuration examples, operation examples, and other examples described so far may be combined and applied in a desired manner.

Embodiments of the disclosure may be configured as follows.

(1)

A memory controller configured to control a flash memory, the memory controller including a microprocessor configured to execute each of access processing for data on the flash memory and update processing of updating predetermined region management information in accordance with the access processing, in which the microprocessor is configured to determine, on the basis of the region management information that defines correspondences between logical addresses of logical pages and virtual addresses of virtual pages included in a virtual block including multiple physical blocks belonging to multiple channels of the flash memory, one of the virtual addresses that is to be accessed during the access processing, and the microprocessor is configured to, in executing write processing for the data as the access processing on the basis of the one of the virtual addresses thus determined, perform editing of the region management information on a cache region every time the microprocessor executes the write processing, and execute the update processing on the region management information, by writing and saving the region management information after the editing into the flash memory with a frequency reduced as compared with every execution of the write processing.

(2)

The memory controller according to (1), in which the virtual pages included in the virtual block each include a spare region that is provided per physical page, and the microprocessor is configured to, in executing the write processing in units of the virtual pages, also write logical address information indicating corresponding one of the logical addresses into the spare region in a write-target virtual page among the virtual pages.

(3)

The memory controller according to (2), in which the microprocessor is configured to, in a case where power to the flash memory and to the memory controller has transitioned from an ON state to an OFF state at a point in time before the region management information is written and saved into the flash memory, read, during activation processing when the power thereafter returns to the ON state from the OFF state, the logical address information from each of a plurality of the spare regions included in a virtual block that has been in middle of writing among a plurality of the virtual blocks, and perform, during the activation processing, editing of any unupdated region management information out of the region management information on the cache region, using the logical address information thus read.

(4)

The memory controller according to any one of (1) to (3), in which the microprocessor is configured to write and save the region management information after the editing into the flash memory, in a case where the write processing is completed up to a last page of the virtual pages included in the virtual block, or in a case where a free space on the cache region is smaller than or equal to a threshold.

(5)

The memory controller according to any one of (1) to (4), in which the microprocessor is configured to allow, of a plurality of the virtual blocks, one into which the data is written during the write processing and one into which the region management information after the editing is written and saved to be different from each other in the flash memory.

(6)

A flash memory system including:
the memory controller according to any one of (1) to (5); and
the flash memory.

The memory controller and the flash memory system according to at least one embodiment of the disclosure each make it possible to increase an efficiency of writing data.

1. A memory controller configured to control a flash memory, the memory controller comprising a microprocessor configured to execute each of access processing for data on the flash memory and update processing of updating predetermined region management information in accordance with the access processing, wherein
the microprocessor is configured to determine, on a basis of the region management information that defines correspondences between logical addresses of logical pages and virtual addresses of virtual pages included in a virtual block including multiple physical blocks belonging to multiple channels of the flash memory, one of the virtual addresses that is to be accessed during the access processing, and
the microprocessor is configured to, in executing write processing for the data as the access processing on a basis of the one of the virtual addresses thus determined,
perform editing of the region management information on a cache region every time the microprocessor executes the write processing, and
execute the update processing on the region management information, by writing and saving the region management information after the editing into the flash memory with a frequency reduced as compared with every execution of the write processing.

2. The memory controller according to claim 1, wherein
the virtual pages included in the virtual block each include a spare region that is provided per physical page, and
the microprocessor is configured to, in executing the write processing in units of the virtual pages, also write logical address information indicating corresponding one of the logical addresses into the spare region in a write-target virtual page among the virtual pages.

3. The memory controller according to claim 2, wherein
the microprocessor is configured to, in a case where power to the flash memory and to the memory controller has transitioned from an ON state to an OFF state at a point in time before the region management information is written and saved into the flash memory,
read, during activation processing when the power thereafter returns to the ON state from the OFF state, the logical address information from each of a plurality of the spare regions included in a virtual block that has been in middle of writing among a plurality of the virtual blocks, and
perform, during the activation processing, editing of any unupdated region management information out of the region management information on the cache region, using the logical address information thus read.

4. The memory controller according to claim 1, wherein the microprocessor is configured to write and save the region management information after the editing into the flash memory, in a case where the write processing is completed up to a last page of the virtual pages included in the virtual block, or in a case where a free space on the cache region is smaller than or equal to a threshold.

5. The memory controller according to claim 1, wherein the microprocessor is configured to allow, of a plurality of the virtual blocks, one into which the data is written during the write processing and one into which the region management information after the editing is written and saved to be different from each other in the flash memory.

6. A flash memory system comprising:
the memory controller according to claim 1; and the flash memory.
